(19) United States
(12) Patent Application Publication
(10) Pub. No.: US 2022/0107589 A1
(43) Pub. Date: Apr. 7, 2022

(54) DRUM MEMBER AND IMAGE FORMING APPARATUS

(71) Applicant: FUJIFILM Business Innovation Corp., Tokyo (JP)

(72) Inventors: Yosuke TSUTSUMI, Kanagawa (JP); Tomoaki YOSHIOKA, Kanagawa (JP); Yoko MIYAMOTO, Kanagawa (JP); Toshiaki BABA, Kanagawa (JP); Tomohiro WADA, Kanagawa (JP)

(73) Assignee: FUJIFILM Business Innovation Corp., Tokyo (JP)

(21) Appl. No.: 17/329,687

(22) Filed: May 25, 2021

(30) Foreign Application Priority Data
Oct. 5, 2020 (JP) 2020-168554

(51) Int. Cl. G03G 15/16

(52) U.S. Cl. CPC G03G 15/161

(57) ABSTRACT

A drum member includes a drum body having a hollow cylindrical shape and a sheet member wrapped around the drum body, and an elastic adhesive disposed between the drum body and the sheet member.

### CROSS-REFERENCE TO RELATED APPLICATIONS

This application is based on and claims priority under 35 USC 119 from Japanese Patent Application No. 2020-168554 filed Oct. 5, 2020.

### BACKGROUND

### (i) Technical Field

The present disclosure relates to a drum member and an image forming apparatus.

### (ii) Related Art

Japanese Unexamined Patent Application Publication No. 58-005769 discloses a transfer device that transfers an image on an image carrier. The transfer device includes a transfer material transport unit, a gripper piece, and a switch member. The transfer material transport unit endlessly moves a transfer material along a circulation movement path. The gripper piece is attached to the transport unit, is supported by a rotation shaft so as to rotate with respect to a base member, and grips a leading edge of the transfer material. The switch member is attached on the base member side. The presence of the transfer material in a gripper is detected by partially cutting the gripper piece at the switch member position.

### SUMMARY

In a drum member including a drum body having a hollow cylindrical shape and a sheet member wrapped around the drum body, the sheet member may be released from the drum body.

Aspects of non-limiting embodiments of the present disclosure relate to a drum member including a drum body having a hollow cylindrical shape and a sheet member wrapped around the drum body. The sheet member is unlikely to be released from the drum body compared with a drum member in which only a non-elastic adhesive is disposed between the drum body having a hollow cylindrical shape and the sheet member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a drum member including a drum body having a hollow cylindrical shape, a sheet member wrapped around the drum body, and an elastic adhesive disposed between the drum body and the sheet member.

### BRIEF DESCRIPTION OF THE DRAWINGS

Exemplary embodiments of the present disclosure will be described in detail based on the following figures, wherein:

FIG. 1 is a schematic view of the structure of an image forming apparatus according to a first exemplary embodiment;

FIG. 2 is a perspective view of the structure of an opposing drum and the surrounding area according to the first exemplary embodiment;

FIG. 3 is a perspective view of a gripper according to the first exemplary embodiment;

FIG. 4 is a side cross-sectional view of the opposing drum according to the first exemplary embodiment;

FIG. 5 is a developed view of the sheet member according to the first exemplary embodiment;

FIG. 6 is an enlarged perspective view of the attachment of one edge portion of the sheet member according to the first exemplary embodiment in the circumferential direction;

FIG. 7 is an enlarged side cross-sectional view of the attachment of one edge portion of the sheet member according to the first exemplary embodiment in the circumferential direction;

FIG. 8 is an enlarged perspective view of the attachment of the other edge portion of the sheet member according to the first exemplary embodiment in the circumferential direction;

FIG. 9 is an enlarged side cross-sectional view of the attachment of the other edge portion of the sheet member according to the first exemplary embodiment in the circumferential direction;

FIG. 10 is an enlarged perspective view of the attachment of one edge portion of a sheet member according to Modification in the circumferential direction;

FIG. 11 is an enlarged side cross-sectional view of the attachment of one edge portion of the sheet member according to Modification in the circumferential direction;

FIGS. 12A and 12B are enlarged plan views of the attachment of a first attachment member according to Modification with a screw;

FIG. 13 is a developed view of a sheet member according to Modification 1;

FIG. 14 is a side cross-sectional view of an opposing drum according to Modification 2; and

FIG. 15 is a schematic view of the structure of an image forming apparatus according to a second exemplary embodiment.

### DETAILED DESCRIPTION

Exemplary embodiments of the present disclosure will be described below.

The upper limit or lower limit of one numerical range in stepwise numerical ranges in the exemplary embodiments may be replaced by the upper limit or lower limit of another stepwise numerical range. The upper limit or lower limit of any numerical range described in the exemplary embodiments may be replaced by the values described in Examples.

In the exemplary embodiments, the term “step” includes not only an independent step but also a step that cannot be clearly distinguished from other steps but accomplishes the intended purpose.

In the description of exemplary embodiments with reference to the drawings in the exemplary embodiments, the structures of the exemplary embodiments are not limited to the structures shown in the drawings. The sizes of the members in each of the drawings are conceptual sizes, and the relative relationship between the sizes of the members is not limited to that shown in the drawings.

In the exemplary embodiments, each component may contain multiple corresponding substances. In exemplary embodiments, the amount of each component in a composition refers to, when there are multiple substances corresponding to each component in the composition, the total amount of the substances present in the composition, unless otherwise specified.

A drum member according to an exemplary embodiments includes a drum body having a hollow cylindrical shape and a sheet member wrapped around the drum body, and an elastic adhesive disposed between the drum body and the sheet member.

In the drum member, the sheet member is, for example, removably attached to the drum body by fixing attachment parts to the drum body with an adhesive, or directly fixed to the drum body with an adhesive. In other words, an adhesive is disposed between the drum body and the sheet member. However, for example, exposure of the drum member to repeated vibrations or repeated local stress generated by contact between members may degrade the adhesive disposed between the drum body and the sheet member, which may cause release of the sheet member from the drum body.

In contrast, the use of an elastic adhesive as an adhesive instead of a non-elastic adhesive may reduce repeated vibrations or repeated local stress generated by contact between members even if the drum member undergoes the vibrations or the stress.

The above configuration may thus prevent release of the sheet member from the drum body in the drum member according to the exemplary embodiments.

The drum member according to the exemplary embodiments will be described below.

Examples of the drum body include solid cylindrical or hollow cylindrical members made of metals (e.g., copper, aluminum, zinc, chromium, nickel, molybdenum, vanadium, indium, gold, and platinum), alloys (e.g., stainless steel), or other metals.

At least one recess for storing a holding part associated with transport of a recording medium may be formed on the outer circumference of the drum body.

The drum body may have any outer diameter (diameter), but may have a large size because an elastic layer is replaceable. The outer diameter (diameter) of the base is, for example, in the range of 200 mm or more and 350 mm or less, or may be in the range of 200 mm or more and 300 mm or less.

The length of the base in the axial direction is not limited and appropriately selected according to application. The length of the base in the axial direction is, for example, in the range of 600 mm or more and 1000 mm or less.

The outer diameter (diameter) of the drum body is preferably 30 times or more the thickness of the sheet member, more preferably 30 times or more and 45 times or less the thickness of the sheet member, still more preferably 32 times or more and 38 times or less the thickness of the sheet member.

Examples of the sheet member include a sheet-shaped member formed of an elastic layer. The elastic layer contains an elastic material and may contain various additives, such as a conductive agent, as appropriate. The elastic layer may have a surface layer on its surface.

The elastic layer may be a foam elastic layer or a non-foam elastic layer. The foam elastic layer is, for example, a layer made of a material (i.e., foam) having bubbles formed by foaming with a foaming agent, and the non-foam elastic layer is a layer made of a material (i.e., non-foam) without bubbles formed by foaming with a foaming agent.

Examples of the elastic material include nitrile rubber, isoprene rubber, butadiene rubber, ethylene-propylene rubber, ethylene-propylene-diene rubber, epichlorohydrin rubber, epichlorohydrin-ethylene oxide rubber, epichlorohydrin-ethylene oxide-allyl glycidyl ether rubber, styrene-butadiene rubber, acrylonitrile-butadiene rubber, chloroprene rubber, chlorinated polyisoprene, hydrogenated polybutadiene, butyl rubber, silicone rubber, fluorocarbon rubber, natural rubber, and an elastic material formed of a mixture of these rubbers.

Among these elastic materials, polyurethane, silicone rubber, nitrile rubber, epichlorohydrin rubber, epichlorohydrin-ethylene oxide rubber, epichlorohydrin-ethylene oxide-allyl glycidyl ether rubber, ethylene-propylene-diene rubber, acrylonitrile-butadiene rubber, and an elastic material formed of a mixture of these rubbers may be used.

Examples of the conductive agent include electroconductive agents and ion conductive agents.

Examples of electroconductive agents include powders formed of carbon black, such as furnace black, thermal black, channel black, Ketjenblack, acetylene black, and color black; pyrolytic carbon; graphite; metals or alloys, such as aluminum, copper, nickel, and stainless steel; metal oxides, such as tin oxide, indium oxide, titanium oxide, tin oxide-antimony oxide solid solution, and tin oxide-indium oxide solid solution; and a material obtained by subjecting the surface of an insulating material to an electrical conduction treatment.

Examples of ion conductive agents include perchlorates and chlorates, such as tetraethylammonium, lauryltrimethylammonium, and benzyltrialkylammonium; perchlorates and chlorates of alkali metals and alkaline earth metals, such as lithium and magnesium.

The conductive agent may be used alone or in combination of two or more.

The conductive agent may have a primary particle diameter of 1 nm or more and 200 nm or less.

The amount of the electroconductive agent in the elastic layer is preferably 1 part by mass or more and 30 parts by mass or less and more preferably 15 parts by mass or more and 25 parts by mass or less relative to 100 parts by mass of the elastic material.

The amount of the ion conductive agent in the elastic layer is preferably 0.1 parts by mass or more and 5 parts by mass or less and more preferably 0.5 parts by mass or more and 3 parts by mass or less relative to 100 parts by mass of the elastic material.

The elastic layer may contain a vulcanizing agent and a vulcanization accelerator. The elastic layer may contain other additives. Examples of other additives include various known additives for rubber. Specific examples include processing aids (e.g., stearic acid), softeners, plasticizers, curing agents, antioxidants, surfactants, coupling agents, and fillers (e.g., silica, calcium carbonate).

When the elastic layer includes a foam elastic layer, the elastic layer may contain a foaming auxiliary, a foam stabilizer, a catalyst, and other additives.

The elastic layer having a single-layer structure is formed by any method and may be formed by, for example, vulcanizing an elastic layer-forming composition containing an elastic material, a conductive agent, and a vulcanizing agent after forming the elastic layer-forming composition into an intended shape, or by vulcanizing the elastic layer-forming composition while forming the elastic layer-forming composition into an intended shape.

To form a foam elastic layer, for example, an elastic layer-forming composition containing a foaming agent in addition to an elastic material, a conductive agent, and a vulcanizing agent is used.

An elastic body may be formed by the above method using the elastic layer-forming composition described above and then drawn into a sheet to form an elastic layer.

After vulcanization (or vulcanization and foaming), the formed elastic layer may be ground as appropriate.

Vulcanization and foaming for forming a foam elastic layer may be performed simultaneously or successively. When vulcanization and foaming are performed successively, foaming may be carried out after vulcanization.

The temperature and time for vulcanization and foaming are not limited and appropriately set according to the vulcanization agent and the foaming agent used.

Vulcanization and/or foaming may be performed by heating, and the heating temperature may be 50° C. or higher and 200° C. or lower. The vulcanization time is, for example, in the range of 15 minutes or more and 60 minutes or less.

The foam elastic layer may be formed by using a physical foaming agent, such as an inert gas. The inert gas may be supercritical carbon dioxide, nitrogen, or a mixture of these.

The foam elastic layer may be formed by any foaming method. Specific examples of the foaming method include a batch foaming method, a press foaming method, a normal pressure foaming method, a normal pressure secondary foaming method, and steam pressure heating foaming in a vulcanizer.

Examples of the foaming agent used for forming the foam elastic layer and the foaming method include foaming agents and foaming methods described in Japanese Unexamined Patent Application Publication No. 11-106543 and “New Edition, Basic Rubber Technology, revised edition”, edited by the Society of Rubber Science and Technology, Japan.

The elastic layer may be a single layer or may be, for example, a multilayer body including a foam elastic layer and a non-foam elastic layer. The elastic layer having a multilayer structure may be formed by any method that can form a multilayer structure including a foam conductive elastic layer and a non-foam conductive elastic layer. The foam conductive elastic layer and the non-foam conductive elastic layer are formed by the same method as that for forming an elastic layer having a single-layer structure.

Examples of the method for forming a multilayer structure include a method in which a sheet-shaped foam conductive elastic layer and a sheet-shaped non-foam conductive elastic layer are prepared separately and bonded to each other; and a method in which a sheet-shaped non-foam conductive elastic layer prepared in advance is attached to the inner circumference of an outer die, an inner die is then inserted on the inner circumferential side of the non-foam conductive elastic layer, and a foam conductive elastic layer is formed in a gap between the non-foam conductive elastic layer and the inner die, whereby the non-foam conductive elastic layer and the foam conductive elastic layer are stacked on top of each other.

The foam conductive elastic layer and the non-foam conductive elastic layer are bonded to each other by using, for example, an adhesive having electrical conductivity.

The sheet member may be, for example, a sheet-shaped member having an elastic layer and a surface layer on the elastic layer.

The surface layer may contain a polymer material.

Examples of the polymer material include resins, such as acrylic resin, fluorine-modified acrylic resin, silicone-modified acrylic resin, cellulose resin, polyamide resin, polyurethane resin, polycarbonate resin, polyester resin, polyimide resin, epoxy resin, silicone resin, polyvinyl alcohol resin, polyvinyl butyral resin, cellulose resin, polyvinyl acetal resin, ethylene tetrafluoroethylene resin, melamine resin, polyethylene resin, polyvinyl resin, polyarylate resin, polythiophene resin, polyethylene terephthalate resin (PET), and fluororesins (e.g., polyfluorovinylidene resin, tetrafluoroethylene resin, tetrafluoroethylene-perfluoroalkyl vinyl ether copolymer (PFA), and tetrafluoroethylene-hexafluoropropylene copolymer (FEP)). Such a resin may be produced by curing or cross-linking a curable resin with a curing agent or a catalyst.

The polymer material may be used alone or in combination of two or more.

The surface layer may contain a conductive agent from the viewpoint of resistance control.

Examples of the conductive agent include the same conductive agents as those used in the elastic layer described above.

The conductive agent may be used alone or in combination of two or more.

The surface layer may further contain known additives, such as fillers, curing agents, antioxidants, surfactants, and coupling agents.

The surface layer may have any thickness. The thickness of the surface layer is appropriately set in the range of, for example, 1 μm or more and 100 μm or less.

The elastic adhesive is an adhesive that, after adhesion (i.e., after curing), deforms under an external force and restores to its original shape.

Specifically, the elastic adhesive preferably has an elastic modulus of less than 40 MPa and a tensile elongation at break of 40% or more and more preferably has a tensile elongation at break of less than 3 MPa and a tensile elongation at break of 140% or more in view of the release of the sheet member.

The elastic modulus of the elastic adhesive is measured in the following manner.

Elastic adhesives of interest are applied to an extruded PFA sheet (e.g., 50 μm sheet of Teflon (registered trademark) PFA450HP-J available from Chemours-Mitsui Fluoroproducts Co., Ltd.) by using an applicator. Each elastic adhesive is dried under the recommended drying conditions and released from the PFA sheet after 72 hours after application to provide a coating film of the elastic adhesive. During application, the applicator is controlled such that the elastic adhesive has a thickness of about 100 μm.

A test sample is prepared by cutting the coating film of the elastic adhesive into a No. 3 dumbbell shape.

The test sample is subjected to a tensile test.

The tensile test is carried out by using STROGRAPH VE10 available from Toyo Seiki Seisaku-sho, Ltd. equipped with a 1-kN load cell.

The tensile test is carried out at a tension rate of 1 mm/sec, and the tensile strength at 3 to 5% elongation is measured to calculate the elastic modulus.

The tensile elongation at break of the elastic adhesive is measured in the following manner.

A test sample is prepared in the same manner as in the measurement of the elastic modulus of the elastic adhesive.

The test sample is subjected to a tensile test.

The tensile test is carried out by using STROGRAPH VE10 available from Toyo Seiki Seisaku-sho, Ltd. equipped with a 1-kN load cell.

The tensile test is carried out at a tension rate of 1 mm/sec, and the amount of elongation until break is measured to calculate the tensile elongation at break.

If the break point is unclear due to occurrence of necking, the amount of elongation until the upper yield point is measured and calculated as a tensile elongation at break.

When the drum member is used as a member of an electrophotographic device, such as a transfer device, the elastic adhesive may have electrical conductivity. Electrical conductivity means a volume resistivity in the range of 10¹⁰ Ωcm or less (or 10⁷Ωcm or less).

Examples of the elastic adhesive include rubber adhesives, urethane adhesives, silicone adhesives, and modified silicone adhesives.

In particular, the elastic adhesive may be a one-pack room temperature-curable adhesive containing a modified silicone resin in view of the release of the sheet member. In other words, the elastic adhesive may be a one pack-type adhesive containing, as a main component, a modified silicone resin that cures at room temperature (25° C.) Examples of the modified silicone resin include an acrylic modified silicone resin (i.e., acrylic modified silicone polymer).

Examples of suitable commercial products of the elastic adhesive include an elastic adhesive containing chloroprene rubber as a main component (e.g., “TB1521B” available from ThreeBond Co., Ltd., “G17Z” available from Konishi Co., Ltd.), an elastic adhesive containing an acrylic modified silicone polymer as a main component (“Super X No. 8008” available from Cemedine Co., Ltd., “SX-ECA48” available from Cemedine Co., Ltd., “SL220W” available from Cemedine Co., Ltd.), an elastic adhesive containing nitrile rubber as a main component (“540” available from Cemedine Co., Ltd.), and an elastic adhesive containing styrene-butadiene thermoplastic elastomer (SBS) as a main component (“G630N” available from Cemedine Co., Ltd).

The main component means a component contained in the largest quantity in an adhesive.

The drum member according to the exemplary embodiment and an example of an image forming apparatus including the drum member will be described below with reference to the drawings. It is noted that members having substantially the same function may be provided with the same reference symbol throughout the drawings, and the description thereof may be omitted.

### First Exemplary Embodiment

### Image Forming Apparatus 10

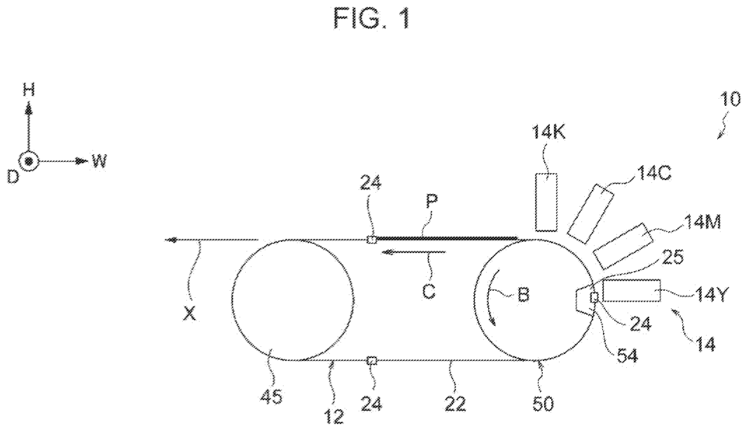

First, the structure of an image forming apparatus 10 according to a first exemplary embodiment will be described. FIG. 1 is a schematic view of the structure of the image forming apparatus 10 according to this exemplary embodiment. In each figure, the arrow H indicates a direction corresponding to the vertical direction and the apparatus up-down direction, the arrow W indicates a direction corresponding to the horizontal direction and the apparatus width direction, and the arrow D indicates a direction corresponding to the horizontal direction and the apparatus depth direction (apparatus anterior-posterior direction). The dimensional ratio between parts shown in each figure in the H direction, the W direction, and the D direction may be different from an actual dimensional ratio.

The image forming apparatus 10 in FIG. 1 is an ink-jet image forming apparatus that forms an ink image (example image) on a recording medium P. Specifically, the image forming apparatus 10 includes an image forming unit 14, a transport mechanism 12, and an opposing drum 50. Hereinafter, parts (the image forming unit 14, the transport mechanism 12, and the opposing drum 50) of the image forming apparatus 10 will be described.

### Image Forming Unit 14

The image forming unit 14 has a function of forming an ink image on a transported recording medium P. Specifically, the image forming unit 14 has ejectors 14Y, 14M, 14C, and 14K (hereinafter referred to as 14Y to 14K), which eject ink onto predetermined ejection positions, as illustrated in FIG. 1.

The ejectors 14Y to 14K are arranged in this order from upstream to downstream in the transport direction of the recording medium P. The ejectors 14Y to 14K are elongated in the width direction of the recording medium P. The width direction of the recording medium P is a direction that crosses (specifically, a direction perpendicular to) the transport direction, or a direction along the apparatus anterior-posterior direction.

In the image forming unit 14, the ejectors 14Y to 14K eject, using a known method, such as a thermal or piezoelectric method, ink droplets onto a recording medium P transported by the transport mechanism 12 to form an ink image on the recording medium P.

### Transport Mechanism 12

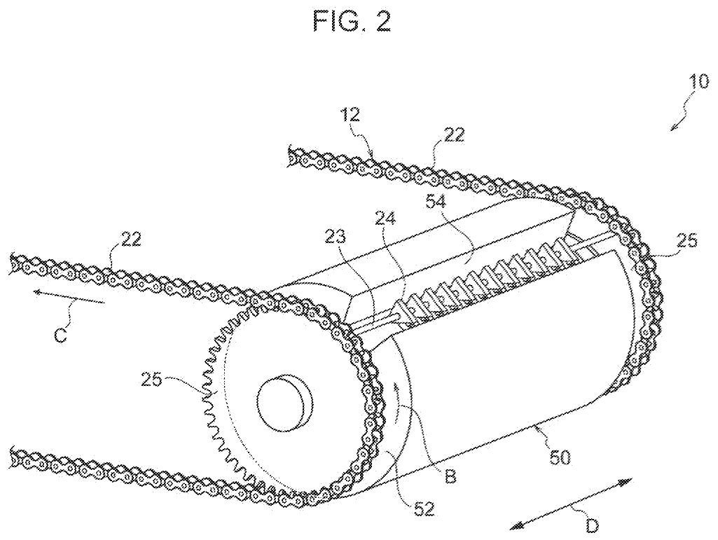

The transport mechanism 12 illustrated in FIG. 1 is a mechanism for transporting the recording medium P. As illustrated in FIG. 1 and FIG. 2, the transport mechanism 12 has a pair of chains 22 and grippers 24. In FIG. 1, one of the pair of chains 22 is illustrated, and the chains 22 and the grippers 24 are simplified.

As illustrated in FIG. 1, the pair of chains 22 each form a ring shape. As illustrated in FIG. 2, the pair of chains 22 are disposed at a distance in the apparatus depth direction (direction D in the figure). One of the pair of chains 22 is wound around the corresponding one of a pair of sprockets 25 disposed on the opposite ends of the opposing drum 50 in the axial direction and the corresponding one of a pair of sprockets 45 (see FIG. 1). As the opposing drum 50 and the pair of sprockets 25 are driven to rotate together in the rotation direction B (the direction of the arrow B), the chains 22 run in the running direction C (the direction of the arrow C).

As illustrated in FIG. 2, attachment members 23 having grippers 24 are placed between the pair of chains 22 so as to extend in the apparatus depth direction. The multiple attachment members 23 are fixed to the pair of chains 22 at a predetermined distance in the running direction C of the chains 22.

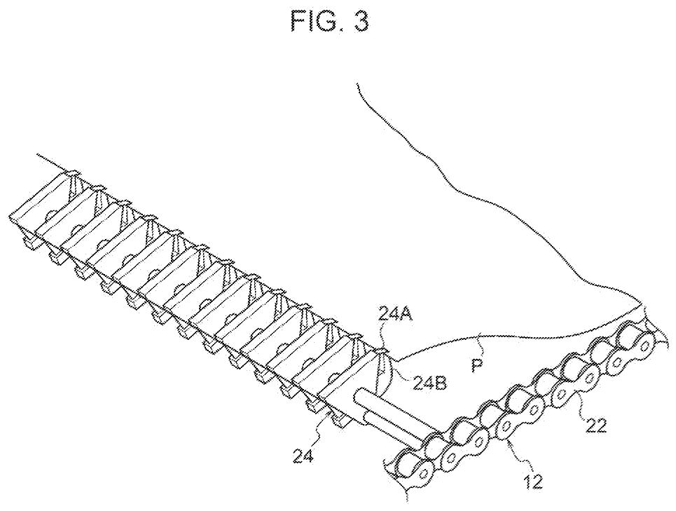

As illustrated in FIG. 2 and FIG. 3, the multiple grippers 24 are attached to each attachment member 23 at a predetermined distance in the apparatus depth direction. The grippers 24 function as holding parts for holding the leading edge portion of a recording medium P. Specifically, each gripper 24 has a claw 24A and a claw base 24B as illustrated in FIG. 3. In each gripper 24, the leading edge portion of the recording medium P is pinched between the claw 24A and the claw base 24B to hold the recording medium P. Each gripper 24 is such that, for example, the claw 24A is urged against the claw base 24B by means of a spring or the like while the claw 24A is opened and closed against the claw base 24B by the action of a cam or the like.

In the transport mechanism 12, the grippers 24 hold the leading edge portion of a recording medium P fed from a storage (not shown) in which recording media P are stored, as illustrated in FIG. 3. The grippers 24 holding the leading edge portion of the recording medium P are stored in a recess 54 formed on the outer circumference of the opposing drum 50, and the recording medium P is disposed on the outer circumferential surface of the opposing drum 50 (specifically, the outer circumferential surface of a sheet member 60 described below). When the opposing drum 50 is driven to rotate in the rotation direction B so that the chains 22 run in the running direction C, the grippers 24 and the opposing drum 50 rotate together, and the recording medium P that is disposed on the outer circumferential surface of the opposing drum 50 and the leading edge portion of which is held by the grippers 24 is transported to the ejection positions of the ejectors 14Y to 14K. When the recording medium P is transported while being disposed on the outer circumferential surface of the sheet member 60 of the opposing drum 50 described below, the recording medium P passes through the ejection positions while it is flat and smooth.

### Opposing Drum 50

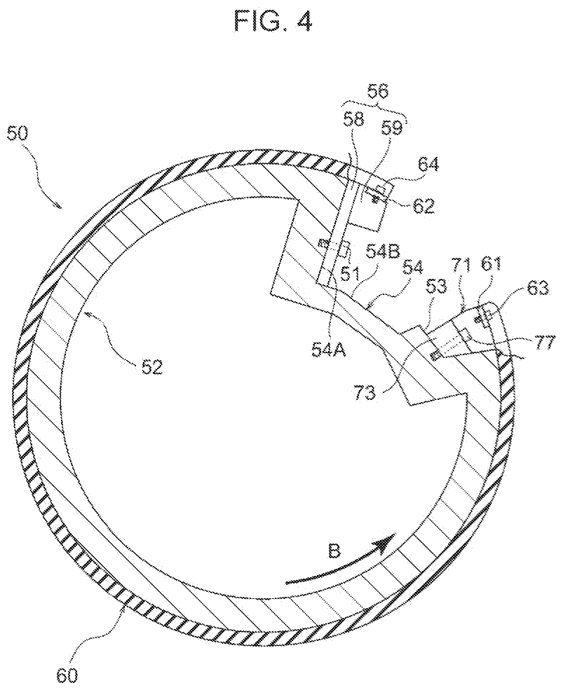

The opposing drum 50 is a drum member that opposes the ejectors 14Y to 14K as illustrated in FIG. 1. Specifically, as illustrated in FIG. 4, the opposing drum 50 includes an opposing drum body 52 serving as an example drum body, the sheet member 60 wrapped around the opposing drum body 52, a first attachment member 61 serving as an example first attachment part, and a second attachment member 62 serving as an example second attachment part. In FIG. 1 and FIG. 2, the opposing drum 50 is simplified.

As illustrated in FIG. 4, the opposing drum body 52 has a cylindrical shape with one recess 54 along the axial direction in part of the opposing drum body 52 in the circumferential direction. The recess 54 has a depth in the radial direction of the opposing drum body 52. Hereinafter, the axial direction of the opposing drum body 52 (opposing drum 50) may be referred to simply as an “axial direction”. Hereinafter, the radial direction of the opposing drum body 52 (opposing drum 50) may be referred to simply as a “radial direction”. Hereinafter, the circumferential direction of the opposing drum body 52 (opposing drum 50) may be referred to simply as a “circumferential direction”. Hereinafter, the upstream side in the rotation direction of the opposing drum 50 may be referred to simply as “upstream”, and the downstream side in the rotation direction of the opposing drum 50 as “downstream”.

As illustrated in FIG. 2, the pair of sprockets 25 is disposed on the opposite ends of the opposing drum body 52 in the axial direction. The pair of sprockets 25 is coaxial with the opposing drum body 52 and rotates together with the opposing drum body 52.

As illustrated in FIG. 4, the sheet member 60 is a sheet-shaped member wrapped around the opposing drum body 52. Specifically, the sheet member 60 is wrapped around the outer circumferential surface of the opposing drum body 52 in a non-bonding manner.

The “sheet shape” refers to a shape, such as the shape of paper or thin plate, that has a property of being able to deform along the outer circumference of the opposing drum body 52. As illustrated in FIG. 4, the length of the sheet member 60 in the circumferential direction is substantially the same as the length of the opposing drum body 52 in the circumferential direction excluding the recess 54.

The coefficient of friction between the outer circumferential surface of the opposing drum body 52 and the sheet member 60 may be large. Since the sheet member 60 is not bonded to the outer circumferential surface of the opposing drum body 52 as described below, a large coefficient of friction may make it difficult for the sheet member 60 to shift with respect to the outer circumferential surface of the opposing drum body 52 and may reduce lifting of the sheet member 60 from the outer circumferential surface. The coefficient of friction is adjusted with, for example, a material selected as the sheet member 60 and surface treatment on the surface to be in contact with the outer circumferential surface of the opposing drum body 52.

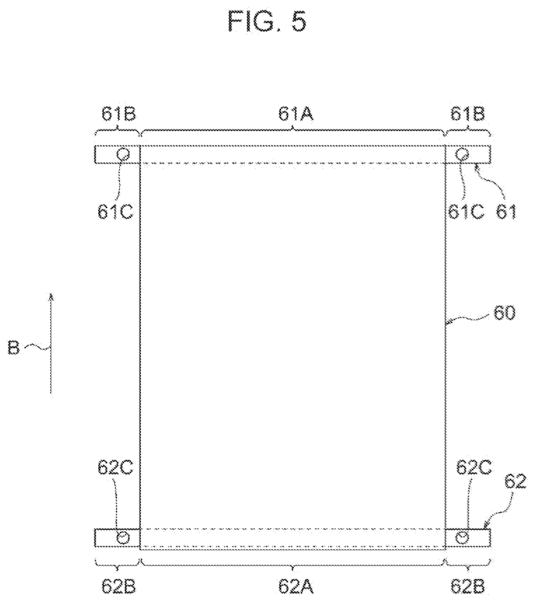

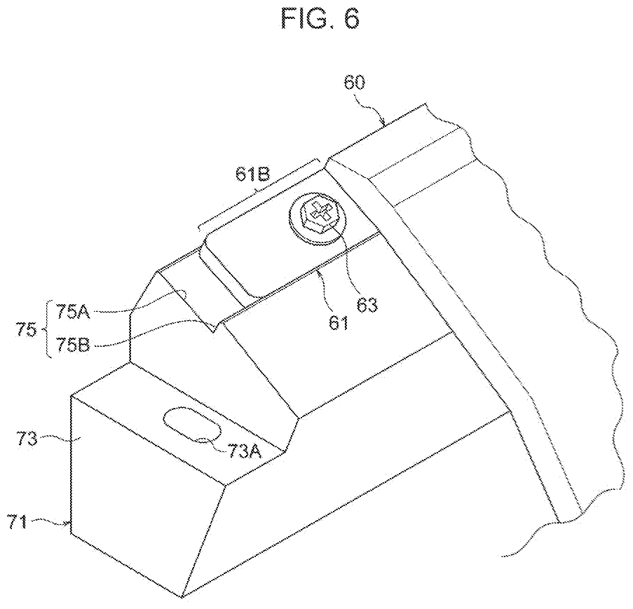

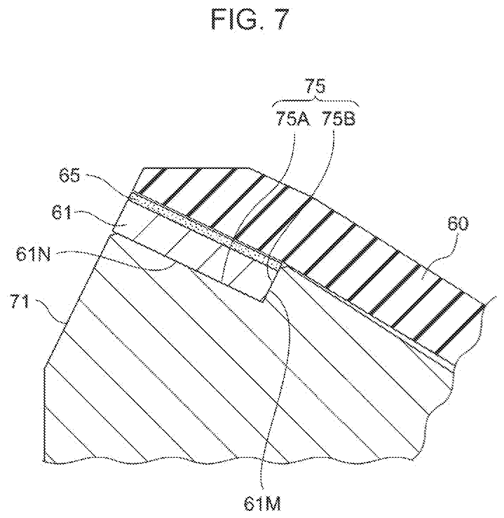

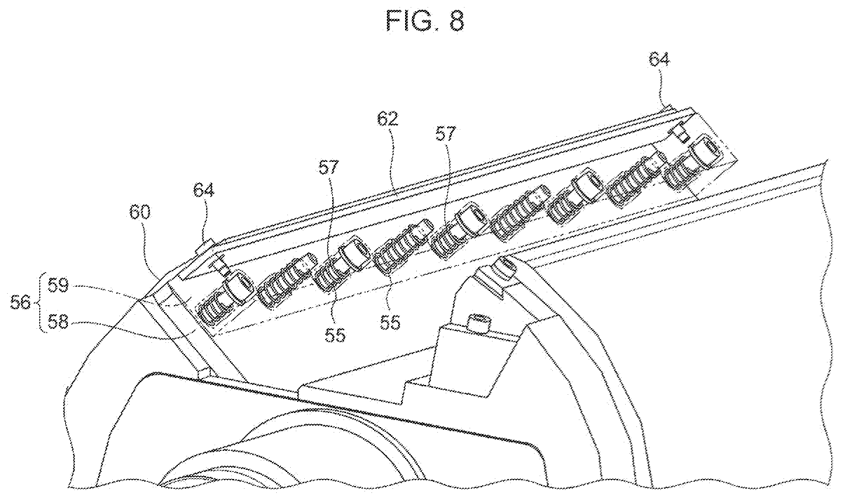

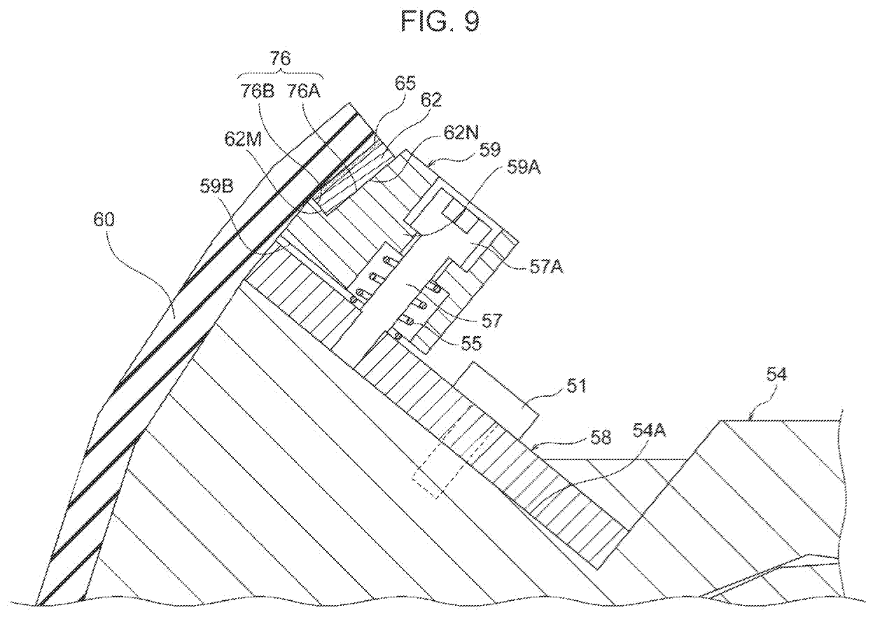

As illustrated in FIG. 4 and FIG. 5, the first attachment member 61 is disposed on the inner circumferential surface of one edge portion (specifically, downstream edge portion) of the sheet member 60 in the circumferential direction so as to extend in the axial direction (see FIG. 6 and FIG. 7). The second attachment member 62 is disposed on the inner circumferential surface of the other edge portion (specifically, upstream edge portion) of the sheet member 60 in the circumferential direction so as to extend in the axial direction (see FIG. 8 and FIG. 9).

The first attachment member 61 and the second attachment member 62 are attached to the sheet member 60 with an elastic adhesive 65 (see FIG. 7 and FIG. 9).

As illustrate in FIG. 4 to FIG. 7, the first attachment member 61 and the second attachment member 62 each have a plate shape with a thickness in the radial direction and are elongated in the axial direction. The first attachment member 61 and the second attachment member 62 are made of a metal material, such as stainless steel or aluminum.

Specifically, as illustrated in FIG. 5, the first attachment member 61 has a pair of protrusion portions 61B protruding on the opposite sides in the axial direction from the sheet member 60 and a central portion 61A between the pair of protrusion portions 61B, whereas the second attachment member 62 has a pair of protrusion portions 62B protruding on the opposite sides in the axial direction from the sheet member 60 and a central portion 62A between the pair of protrusion portions 62B.

The first attachment member 61 is disposed upstream of the downstream edge of the sheet member 60, and the central portion 61A is disposed in the range of the sheet member 60 as viewed in the thickness direction of the sheet member 60 (as viewed in the radial direction). In other words, the central portion 61A entirely overlaps the sheet member 60 as viewed in the thickness direction of the sheet member 60 (as viewed in the radial direction). In this exemplary embodiment, the downstream edge of the sheet member 60 overlaps the downstream edge of the first attachment member 61 as viewed in the thickness direction of the sheet member 60 (as viewed in the radial direction).

Each of the pair of protrusion portions 61B has a through-hole 61C through which a screw 63 (see FIG. 4 and FIG. 6) passes and which is larger than the shaft of the screw 63. In other words, the inner diameter of the through-hole 61C is larger than the diameter of the shaft of the screw 63. Since the inner diameter of the through-hole 61C is larger than the diameter of the shaft of the screw 63, the first attachment member 61 can move in the axial direction and the circumferential direction relative to the screw 63 passing through the through-hole 61C. The through-hole 61C is smaller than the head of the screw 63.

The second attachment member 62 is disposed downstream of the upstream edge of the sheet member 60, and the central portion 62A is disposed in the range of the sheet member 60 as viewed in the thickness direction of the sheet member 60 (as viewed in the radial direction). In other words, the central portion 62A entirely overlaps the sheet member 60 as viewed in the thickness direction of the sheet member 60 (as viewed in the radial direction).

Each of the pair of protrusion portions 62B has a through-hole 62C through which a screw 64 (see FIG. 4 and FIG. 8) passes. The through-hole 62C is larger than the shaft of the screw 64. In other words, the inner diameter of the through-hole 62C is larger than the diameter of the shaft of the screw 64. Since the inner diameter of the through-hole 62C is larger than the diameter of the shaft of the screw 64, the second attachment member 62 can move in the axial direction and the circumferential direction relative to the screw 64 passing through the through-hole 62C. The through-hole 62C is smaller than the head of the screw 64.

As illustrated in FIG. 4, a step 53 is formed on one side (upstream side) of a bottom wall 54B in the circumferential direction in the recess 54 of the opposing drum body 52. The step 53 protrudes outward from the bottom wall 54B in the radial direction. A receiving member 71 serving as an example receiving part is disposed on the step 53. The receiving member 71 is a member to which the first attachment member 61 is attached.

The receiving member 71 is elongated in the axial direction of the opposing drum body 52 and has a substantially rectangular parallelepiped shape in which the length in the radial direction is larger than the length in the circumferential direction. As illustrated in FIG. 4 and FIG. 6, a protrusion 73 is formed on the inner side in the radial direction on each of the opposite side walls of the receiving member 71 in the axial direction. The protrusion 73 protrudes outward in the axial direction.

As illustrated in FIG. 4, the receiving member 71 is attached to the step 53 on one side of the bottom wall 54B of the opposing drum body 52 in the circumferential direction such that the protrusion 73 is fixed to the step 53 with a screw 77. The receiving member 71 can be detached from the step 53 of the opposing drum body 52 by removing the screw 77. In other words, the receiving member 71 is detachably attached to the opposing drum body 52. As illustrated in FIG. 6, a through-hole 73A, which is formed in the protrusion 73 and through which the screw 77 passes, is an elongated hole elongated in the circumferential direction.

As illustrated in FIG. 4 and FIG. 6, the screw 63 passing through the through-hole 61C (see FIG. 5) of the first attachment member 61 is screwed into the receiving member 71 attached to the opposing drum body 52. The pair of protrusion portions 61B is accordingly attached to the opposing drum body 52 through the receiving member 71.

The first attachment member 61 can be detached from the receiving member 71 by removing the screw 63. In other words, the first attachment member 61 is removably attached to the opposing drum body 52 through the receiving member 71.

As illustrated in FIG. 6 and FIG. 7, the receiving member 71 has a positioning portion 75. The positioning portion 75 positions one edge portion (downstream edge portion) of the sheet member 60 relative to the opposing drum body 52 such that the first attachment member 61 abuts against the upstream side of the positioning portion 75 in the circumferential direction. As illustrated in FIG. 7, the positioning portion 75 includes a contact surface 75A and an abutting surface 75B. The contact surface 75A comes into contact with an inner surface 61N of the first attachment member 61 on the inner side in the radial direction. The abutting surface 75B abuts against an edge surface 61M of the first attachment member 61 on the upstream side.

When the inner surface 61N of the first attachment member 61 comes into contact with the contact surface 75A and the edge surface 61M of the first attachment member 61 abuts against the abutting surface 75B, the downstream edge portion of the sheet member 60 is positioned relative to the opposing drum body 52.

As illustrated in FIG. 4, a receiving member 56 serving as an example receiving part is disposed on the other side (downstream side) of the bottom wall 54B in the circumferential direction in the recess 54 of the opposing drum body 52. The receiving member 56 is a member to which the other edge portion (upstream edge portion) of the sheet member 60 in the circumferential direction is attached.

As illustrated in FIG. 4, FIG. 8, FIG. 9, the receiving member 56 has a plate member 58 and a movable body 59 having a rectangular parallelepiped shape. The plate member 58 is elongated in the axial direction of the opposing drum body 52 and has a plate shape with a thickness in the circumferential direction. The movable body 59 has a rectangular parallelepiped shape elongated in the axial direction of the opposing drum body 52.

The receiving member 56 is attached to a side wall 54A on the downstream side in the recess 54 of the opposing drum body 52 by screwing a screw 51 into the plate member 58. The receiving member 56 can be detached from the side wall 54A of the opposing drum body 52 by removing the screw 51. In other words, the receiving member 56 is detachably attached to the opposing drum body 52.

As illustrated in FIG. 4 and FIG. 8, the screw 64 passing through the through-holes 62C (see FIG. 5) of the second attachment member 62 is screwed into the movable body 59 of the receiving member 56 attached to the opposing drum body 52. The pair of protrusion portions 62B is accordingly attached to the opposing drum body 52 through the receiving member 56.

The second attachment member 62 can be detached from the receiving member 56 by removing the screw 64. In other words, the second attachment member 62 is removably attached to the opposing drum body 52 through the receiving member 56.

As illustrated in FIG. 9, the receiving member 56 has a positioning portion 76. The positioning portion 76 positions the other edge portion (upstream edge portion) of the sheet member 60 relative to the opposing drum body 52 such that the second attachment member 62 abuts against the downstream side of the positioning portion 76 in the circumferential direction. The positioning portion 76 includes a contact surface 76A and an abutting surface 76B. The contact surface 76A comes into contact with an inner surface 62N of the second attachment member 62 on the inner side in the radial direction. The abutting surface 76B abuts against an edge surface 62M of the second attachment member 62 on the downstream side.

When the inner surface 62N of the second attachment member 62 comes into contact with the contact surface 76A and the edge surface 62M of the second attachment member 62 abuts against the abutting surface 76B, the upstream edge portion of the sheet member 60 is positioned relative to the opposing drum body 52.

As illustrated in FIG. 8 and FIG. 9, the plate member 58 has a plurality of pins 57 extending toward the upstream side. As illustrated in FIG. 8, the plurality of pins 57 is arranged in the axial direction. When the plurality of pins 57 is inserted into the movable body 59, the movable body 59 is attached to the plate member 58 through the pins 57 such that the movable body 59 can move in the circumferential direction (in the thickness direction of the plate member 58). Specifically, as illustrated in FIG. 9, the movable body 59 can move in the circumferential direction in the range in which a flange 59A formed on the movable body 59 abuts against heads 57A of the pins 57 and an edge surface 59B of the movable body 59 abuts against the plate member 58. Compression springs 55 attached to the pins 57 push the movable body 59 toward the upstream side. The second attachment member 62 attached to the movable body 59 is accordingly pushed toward the upstream side in the circumferential direction. As a result, the sheet member 60 attached to the receiving member 71 and the receiving member 56 experiences tension in the circumferential direction. In other words, the movable body 59 pushes the second attachment member 62 in such a direction that the sheet member 60 experiences tension in the circumferential direction.

As described above, in this exemplary embodiment, the sheet member 60 is attached to the opposing drum body 52 only at the opposite edge portions in the circumferential direction by using the first attachment member 61 and the second attachment member 62. Thus, the sheet member 60 is not secured to the outer circumferential surface of the opposing drum body 52 except at the opposite edge portions in the circumferential direction at which the sheet member 60 is attached to the opposing drum body 52. In other words, the opposing drum 50 does not have members that secure portions other than the opposite edge portions of the sheet member 60 in the circumferential direction, such as attachment parts used to attach the edge portions of the sheet member 60 in the axial direction to the opposing drum body 52 in the circumferential direction.

### Operation of Exemplary Embodiment

Next, the operation of this exemplary embodiment will be described.

In this exemplary embodiment, the first attachment member 61 and the second attachment member 62 are each bonded to the sheet member 60 with the elastic adhesive 65 as described above.

The elastic adhesive 65 may thus reduce repeated vibrations or repeated local stress which may be applied to the opposing drum 50.

This may prevent or reduce the release of the sheet member 60 from the opposing drum body 52.

### Modification 1 of Opposing Drum 50

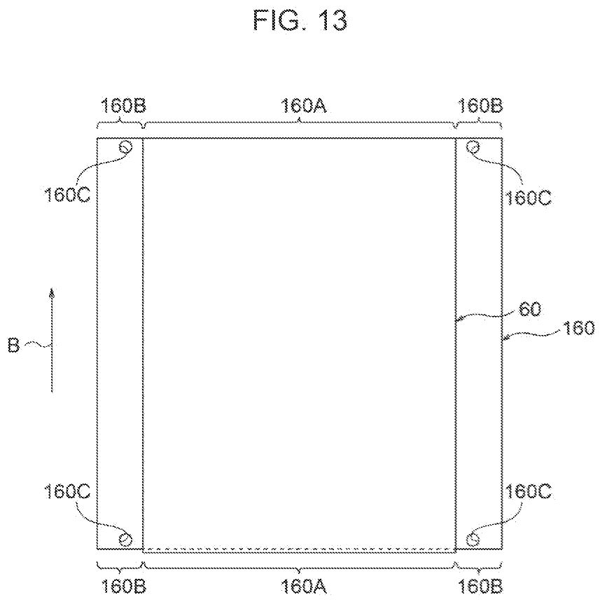

In this exemplary embodiment, the first attachment member 61 and the second attachment member 62 are attached to the sheet member 60 in the opposing drum 50. However, the present disclosure is not limited to this configuration. In this exemplary embodiment, as illustrated in FIG. 13, a plate-shaped attachment member 160 serving as an example attachment part may be disposed on the entire inner circumferential surface of the sheet member 60 in the opposing drum 50.

Like the first attachment member 61 and the second attachment member 62, the plate-shaped attachment member 160 has a pair of protrusion portions 160B protruding on the opposite sides in the axial direction from the sheet member 60 and a central portion 160A between the pair of protrusion portions 160B.

Each of the pair of protrusion portions 160B has a through-hole 160C through which the screw 63 (see FIG. 4 and FIG. 6) passes and which is larger than the shaft of the screw 63, as in the first attachment member 61 and the second attachment member 62. In other words, the inner diameter of the through-hole 160C is larger than the diameter of the shaft of the screw 63. Since the inner diameter of the through-hole 160C is larger than the diameter of the shaft of the screw 63, the attachment member 160 can move in the axial direction and the circumferential direction relative to the screw 63 passing through the through-hole 160C. The through-hole 160C is smaller than the head of the screw 63.

The sheet member 60 and the attachment member 160 are bonded to each other with the elastic adhesive 65.

In Modification 1 of the opposing drum 50, the elastic adhesive 65 may thus reduce repeated vibrations or repeated local stress which may be applied to the opposing drum 50.

This may prevent or reduce the release of the sheet member 60 from the opposing drum body 52.

### Modification 2 of Opposing Drum 50

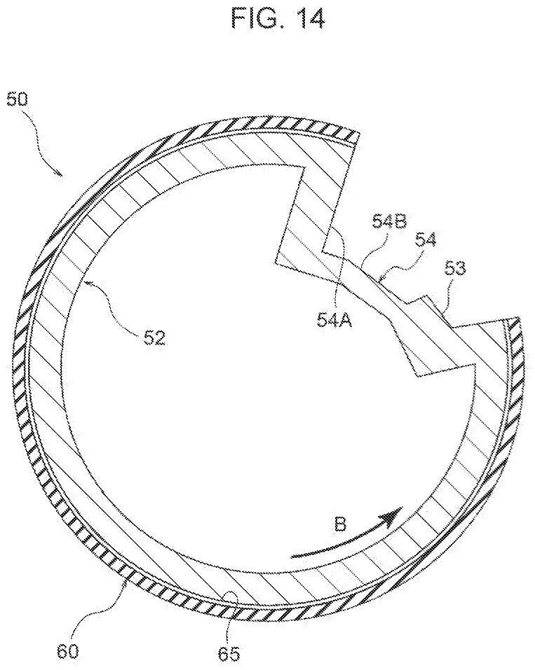

In the opposing drum 50, the sheet member 60 and the opposing drum body 52 may be bonded to each other with an elastic adhesive as illustrated in FIG. 14. In other words, the sheet member 60 may be directly bonded to the outer circumferential surface of the opposing drum body 52 with the elastic adhesive 65.

Since the sheet member 60 is directly bonded to the outer circumferential surface of the opposing drum body 52 with the elastic adhesive 65 in Modification 2 of the opposing drum 50, the elastic adhesive 65 may reduce repeated vibrations or repeated local stress which may be applied to the opposing drum 50. This may prevent or reduce the release of the sheet member 60 from the opposing drum body 52.

### TEST EXAMPLES

Hereinafter, test examples for supporting the effect of preventing or reducing the release of the sheet member 60 from the opposing drum body 52 in this exemplary embodiment are described.

### Test Examples 1 to 3, Comparative Example 1

An elastic layer-forming composition containing a raw material for an elastic material (urethane rubber raw material), and additives such as a conductive agent, a vulcanizing agent, and a foaming agent is prepared, placed in a mold, and subjected to vulcanization, foaming, and forming to produce a foam conductive elastic body. The produced foam conductive elastic body is pressed and drawn into a sheet to produce a sheet-shaped foam conductive elastic layer.

An elastic layer-forming composition containing a raw material (urethane rubber raw material) for an elastic material, and additives such as a conductive agent and a vulcanizing agent is prepared, placed in a mold, and subjected to vulcanization and forming to produce a non-foam conductive elastic body. The produced non-foam conductive elastic body is pressed and drawn into a sheet to produce a sheet-shaped non-foam conductive elastic layer.

The produced sheet-shaped foam conductive elastic layer and the produced sheet-shaped non-foam conductive elastic layer are attached to each other with a conductive adhesive to produce an elastic layer having a multilayer structure.

After the surface of the non-foam conductive elastic layer in the produced elastic layer is ground, a surface layer (fluororesin layer) is formed on the non-foam conductive elastic layer.

The sheet-shaped member made of urethane rubber produced by the above procedure is cut into a size 50 mm long×15 mm wide×7 mm thick to produce a specimen.

Next, a plate-shaped fixture 30 mm long×30 mm wide×3 mm thick is bonded to each of the opposite ends of the specimen in the longitudinal direction at a bonding width of 10 mm×a bonding length of 15 mm. Table 1 shows adhesives used.

### Evaluation

The produced specimen with the fixtures is subjected to a tensile test and a repeated elongation test. Specifically, the procedure is as described below.

### Tensile Test

The fixtures at the opposite edges of the specimen with the fixtures in the longitudinal direction are gripped, and the specimen is stretched at a tensile rate of 10 mm/s in the longitudinal direction of the specimen. The specimen is then evaluated on the basis of the following criteria.

A: the release of the fixtures from the specimen is not observed even at a force of 30 N or more.

B: the release of the fixtures from the specimen is not observed even at a force of 20 N or more and less than 30 N.

C: the release of the fixtures from the specimen is observed even at a force of less than 20 N.

### Repeated Elongation Test

The fixtures at the opposite edges of the specimen with the fixtures in the longitudinal direction are gripped, and the specimen is stretched at a force of 5 N and a tensile rate of 10 mm/s in the longitudinal direction of the specimen. This procedure is repeated at a frequency of 60 Hz. The specimen is then evaluated on the basis of the following criteria.

A: the release of the fixtures from the specimen is not observed even after the elongation test is repeated 10,000,000 times.

B: the release of the fixtures from the specimen is not observed even after the elongation test is repeated 5,000,000 times.

C: the release of the fixtures from the specimen is observed before the elongation test is repeated 5,000,000 times.

TABLE 1

| | Adhesive | | | | | |
|---|---|---|---|---|---|---|
| | | | | Tensile | | |
| | | | Elastic | Elongation | Evaluation | |
| | | | Modulus | at Break | Tensile | Elongation |
| | Type | | (MPa) | (%) | Test | Test |
| Test | elastic | chloroprene rubber | 36.8 | 44.4 | B | B |
| Example 1 | adhesive | adhesive | | | | |
| | | (″TB1521B″ available from | | | | |
| | | ThreeBond Co., Ltd.) | | | | |
| Test | elastic | modified silicone-based | 2.1 | 212.3 | A | A |
| Example 2 | adhesive | adhesive | | | | |
| | (conductive | (″Super X No. 8008 White″ | | | | |
| | adhesive) | available from Cemedine | | | | |
| | | Co., Ltd., | | | | |
| | | one-pack room | | | | |
| | | temperature-curable acrylic | | | | |
| | | modified silicone resin- | | | | |
| | | containing adhesive) | | | | |
| Test | elastic | modified silicone-based | 2.9 | 142.8 | A | A |
| Example 3 | adhesive | adhesive | | | | |
| | (conductive | (″SX-ECA48″ available | | | | |
| | adhesive) | from Cemedine Co., Ltd., | | | | |
| | | one-pack room | | | | |
| | | temperature-curable acrylic | | | | |
| | | modified silicone resin- | | | | |
| | | containing adhesive) | | | | |
| Comparative | non-elastic | cellulose/vinyl acetate- | 1438.7 | 8.1 | C | C |
| Example 1 | adhesive | based adhesive | | | | |
| | | (″Cemedine C″ available | | | | |
| | | from Cemedine Co., Ltd.) | | | | |

From the above results, the test examples using the elastic adhesives show better results than the comparative example using the non-elastic adhesive in both the tensile test and the elongation test.

The results indicate that the release of the sheet member 60 from the opposing drum body 52 is prevented or reduced in this exemplary embodiment.

### Other Operations

In this exemplary embodiment, as described above, one edge portion (downstream edge portion) of the sheet member 60 in the circumferential direction is attached to the opposing drum body 52 by using the first attachment member 61, and the other edge portion (upstream edge portion) of the sheet member 60 in the circumferential direction is attached to the opposing drum body 52 by using the second attachment member 62 (see FIG. 4). In replacing the sheet member 60, the first attachment member 61 and the second attachment member 62 are detached from and attached to replace the sheet member 60.

In the structure (hereinafter referred to as a structure A) in which each of one edge portion and the other edge portion of the sheet member 60 in the circumferential direction and each of one edge portion and the other edge portion of the sheet member in the width direction are removably attached to the opposing drum body 52, each of one edge portion and the other edge portion of the sheet member 60 in the circumferential direction and each of one edge portion and the other edge portion of the sheet member in the width direction need to be removed from the opposing drum body 52 to replace the sheet member 60. This process makes the replacement of the sheet member 60 complicated.

In this exemplary embodiment, the sheet member 60 can be replaced by detaching and attaching the first attachment member 61 and the second attachment member 62. This process may make it easier to replace the sheet member 60 than in the structure A.

In this exemplary embodiment, the through-hole 61C formed in each of the pair of protrusion portions 61B of the first attachment member 61 is larger than the shaft of the screw 63 passing through the through-hole 61C. The first attachment member 61 can move in the axial direction and the circumferential direction relative to the screw 63 passing through the through-hole 61C.

Thus, the posture of one edge portion (downstream edge portion) of the sheet member 60 in the circumferential direction with respect to the axial direction of the opposing drum body 52 may be more easily adjusted than that in a structure in which the through-hole 61C has the same size as the shaft of the screw 63.

In this exemplary embodiment, the through-hole 62C formed in each of the pair of protrusion portions 62B of the second attachment member 62 is larger than the shaft of the screw 64 passing through the through-hole 62C. The second attachment member 62 can move in the axial direction and the circumferential direction relative to the screw 64 passing through the through-hole 62C.

Thus, the posture of the other edge portion (upstream edge portion) of the sheet member 60 in the circumferential direction with respect to the axial direction of the opposing drum body 52 may be more easily adjusted than that in a structure in which the through-hole 62C has the same size as the shaft of the screw 64.

In this exemplary embodiment, as illustrated in FIG. 9, the movable body 59 pushes the second attachment member 62 in such a direction that the compression springs 55 apply tension to the sheet member 60 in the circumferential direction. This configuration may prevent or reduce the slack of the sheet member 60 compared with a structure in which the second attachment member 62 is directly fixed to the opposing drum body 52 without the receiving member 56 therebetween.

In this exemplary embodiment, the pair of protrusion portions 61B of the first attachment member 61 protruding on the opposite sides in the axial direction from the sheet member 60 is attached to the opposing drum body 52 through the receiving member 71.

This configuration may prevent or reduce lifting of the sheet member 60, from the opposing drum body 52, on both sides in the axial direction in one edge portion (downstream edge portion) of the sheet member 60 in the circumferential direction compared with a structure in which only a protrusion portion protruding in the circumferential direction from one edge of the sheet member 60 in the circumferential direction is attached to the opposing drum body 52.

In this exemplary embodiment, the pair of protrusion portions 62B of the second attachment member 62 protruding on the opposite sides in the axial direction from the sheet member 60 is attached to the opposing drum body 52 through the receiving member 56.

This configuration may prevent or reduce lifting of the sheet member 60, from the opposing drum body 52, on both sides in the axial direction in the other edge portion (upstream edge portion) of the sheet member 60 in the circumferential direction compared with a structure in which only a protrusion portion protruding in the circumferential direction from the other edge of the sheet member 60 in the circumferential direction is attached to the opposing drum body 52.

In this exemplary embodiment, as illustrated in FIG. 6, the central portion 61A of the first attachment member 61 is disposed in the range of the sheet member 60 as viewed in the thickness direction of the sheet member 60 (as viewed in the radial direction). Thus, the range of the sheet member 60 on the opposing drum body 52 in the circumferential direction may be larger than that in a structure (hereinafter referred to as a structure B) in which the central portion 61A of the first attachment member 61 protrudes in the circumferential direction from one edge of the sheet member 60 in the circumferential direction.

As a result, the sheet member 60 is disposed adjacent to the leading edge of a recording medium P the leading edge portion of which is held by the grippers 24 and disposed on the outer circumferential surface of the opposing drum 50. A portion of the recording medium P adjacent to the leading edge is thus maintained flat and smooth by disposing this portion on the outer circumferential surface of the sheet member 60 compared with the structure B. Compared with the structure B, an ink image can thus be formed in a portion of the recording medium P adjacent to the leading edge, which may reduce the margin of the recording medium P on the leading edge side.

In this exemplary embodiment, as illustrated in FIG. 6 and FIG. 7, the positioning portion 75 positions the downstream edge portion of the sheet member 60 relative to the opposing drum body 52 such that the first attachment member 61 abuts against the upstream side of the positioning portion 75 in the circumferential direction.

This configuration may prevent the downstream edge portion of the sheet member 60 from shifting with respect to the opposing drum body 52 compared with a structure in which the first attachment member 61 can move freely in the circumferential direction.

In this exemplary embodiment, as illustrated in FIG. 9, the positioning portion 76 positions the upstream edge portion of the sheet member 60 relative to the opposing drum body 52 such that the second attachment member 62 abuts against the downstream side of the positioning portion 76 in the circumferential direction.

This configuration may prevent the upstream edge portion of the sheet member 60 from shifting with respect to the opposing drum body 52 compared with a structure in which the second attachment member 62 can move freely in the circumferential direction.

The receiving member 71 to which the first attachment member 61 is attached and the receiving member 56 to which the second attachment member 62 is attached are each detachably attached to the opposing drum body 52.

In the case where the receiving members 71 and 56 wear out, the receiving members 71 and 56 can be replaced without replacing the entire opposing drum body 52.

### Modification of Positioning Portion 75

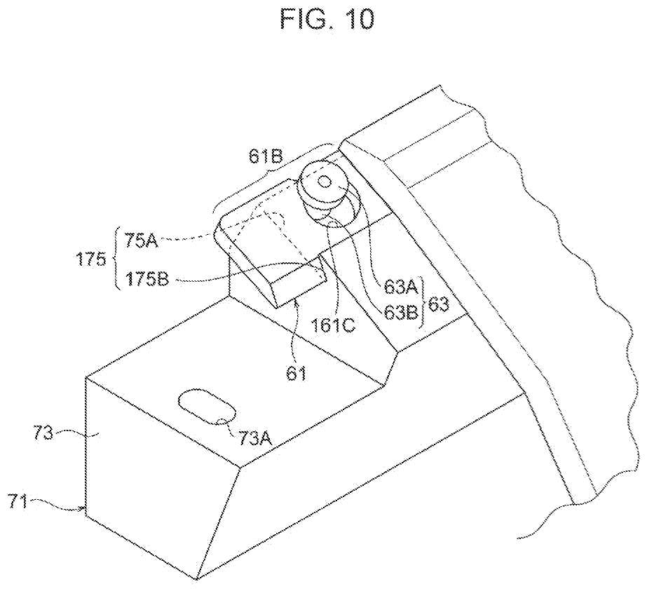

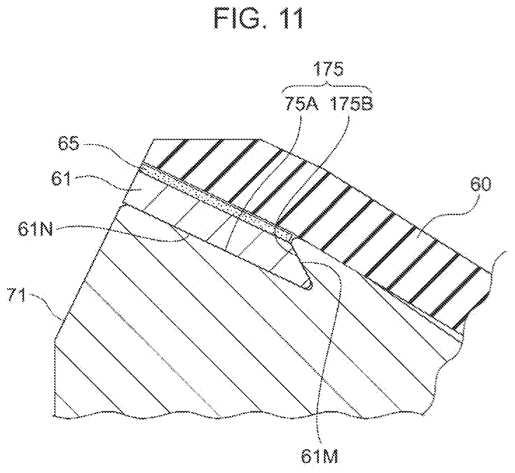

A positioning portion 175 illustrated in FIG. 10 and FIG. 11 may be used as an example positioning portion instead of the positioning portion 75. The positioning portion 175 includes a contact surface 75A and an abutting surface 175B. The contact surface 75A comes into contact with an inner surface 61N of the first attachment member 61 on the inner side in the radial direction. The abutting surface 175B abuts against an edge surface 61M of the first attachment member 61 on the downstream side in the circumferential direction.

In Modification, the first attachment member 61 is sloped such that the edge surface 61M faces outward in the radial direction. The abutting surface 175B is sloped so as to face inward in the radial direction. Therefore, the abutting surface 175B abuts against the edge surface 61M in the circumferential direction and the radial direction.

In Modification, the downstream edge portion of the sheet member 60 is also positioned relative to the opposing drum body 52 when the inner surface 61N of the first attachment member 61 comes into contact with the contact surface 75A and the edge surface 61M of the first attachment member 61 abuts against the abutting surface 175B.

In addition, the movement of the first attachment member 61 outward in the radial direction is restricted by the edge surface 61M abutting against the abutting surface 175B in the radial direction. With the first attachment member 61 abutting against the abutting surface 175B, the positioning portion 175 is in contact with the first attachment member 61 in the radial direction and prevents the first attachment member 61 from moving outward in the radial direction.

Similarly, with the second attachment member 62 abutting against the abutting surface 76B, the positioning portion 76 may be in contact with the second attachment member 62 in the radial direction and may prevent the second attachment member 62 from moving outward in the radial direction.

As described above, in Modification, with the first attachment member 61 abutting against the abutting surface 175B, the positioning portion 175 is in contact with the first attachment member 61 in the radial direction and prevents the first attachment member 61 from moving outward in the radial direction.

This configuration may prevent the downstream edge portion of the sheet member 60 from lifting from the opposing drum body 52 compared with a structure in which the first attachment member 61 can freely move outward in the radial direction of the opposing drum body 52.

Modification of Through-Hole 61C

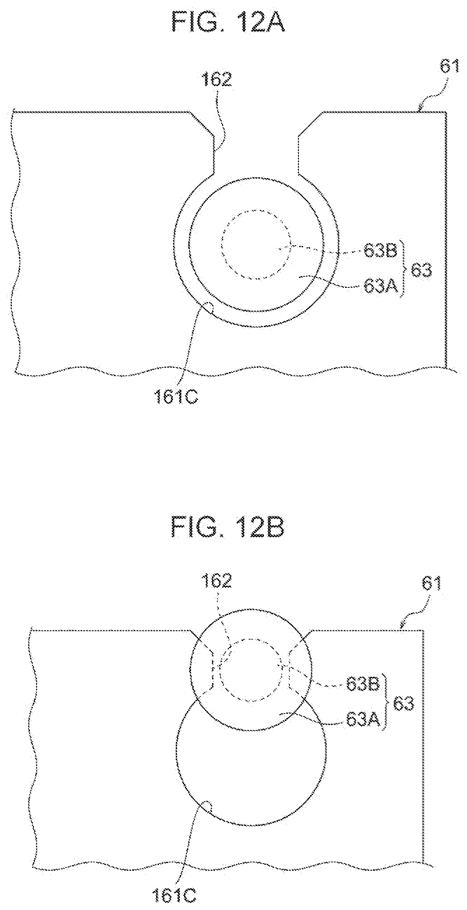

A through-hole 161C illustrated in FIG. 10 and FIGS. 12A and 12B may be used as an example through-hole instead of the through-hole 61C. As illustrated in FIG. 12A, the through-hole 161C is larger than a head 63A of the screw 63. In addition, the first attachment member 61 has a groove 162 communicating with the through-hole 161C. As illustrated in FIG. 12A, the groove 162 has a larger width than a shaft 63B of the screw 63 and a smaller width than the head 63A of the screw 63. The groove 162 is open away from (downstream of) the through-hole 161C.

In the state where the first attachment member 61 is positioned by the positioning portion 175 so as to abut against the abutting surface 175B, the screw 63 is screwed into the receiving member 71 at the position corresponding to the groove 162 (see FIG. 10 and FIG. 12B).

Since the through-hole 161C is larger than the head 63A of the screw 63 in Modification, the first attachment member 61 can be disposed on the receiving member 71 by temporarily screwing the screw 63 into the receiving member 71 and then passing the head 63A of the screw 63 through the through-hole 161C (see FIG. 12A). When the disposed first attachment member 61 is positioned so as to abut against the abutting surface 175B, the groove 162 is disposed at the position corresponding to the shaft 63B of the screw 63 (see FIG. 12B). The first attachment member 61 is then attached to the receiving member 71 by screwing the screw 63 into the receiving member 71.

Since the attachment of the first attachment member 61 can be carried out with the first attachment member 61 on the receiving member 71 after the screw 63 is screwed into the receiving member 71, the attachment of the first attachment member 61 is more efficient than that for a structure in which the through-hole 161C is smaller than the head 63A of the screw 63.

### Other Modifications

In this exemplary embodiment, the first attachment member 61 and the second attachment member 62 are respectively attached to the receiving member 71 and the receiving member 56. However, the present disclosure is not limited to this configuration. For example, the first attachment member 61 and the second attachment member 62 may each be directly attached to the opposing drum body 52. In this case, for example, the first attachment member 61 and the second attachment member 62 are each screwed to the opposing drum body 52.

In this exemplary embodiment, the through-hole 61C formed in each of the pair of protrusion portions 61B of the first attachment member 61 is larger than the shaft of the screw 63 passing through the through-hole 61C. However, the present disclosure is not limited to this configuration. For example, the through-hole 61C may have the same size as the shaft of the screw 63.

In this exemplary embodiment, the through-hole 62C formed in each of the pair of protrusion portions 62B of the second attachment member 62 is larger than the shaft of the screw 64 passing through the through-hole 62C. However, the present disclosure is not limited to this configuration. For example, the through-hole 62C may have the same size as the shaft of the screw 64.

In this exemplary embodiment, as illustrated in FIG. 9, the movable body 59 pushes the second attachment member 62 in such a direction that the compression springs 55 apply tension to the sheet member 60 in the circumferential direction. However, the present disclosure is not limited to this configuration. For example, the second attachment member 62 may be fixed to the opposing drum body 52 without the receiving member 56 therebetween. Alternatively, the movable body 59 may pull the second attachment member 62 in such a direction that tension springs or the like apply tension to the sheet member 60 in the circumferential direction.

In this exemplary embodiment, the pair of protrusion portions 61B of the first attachment member 61 protruding on the opposite sides in the axial direction from the sheet member 60 is attached to the opposing drum body 52 through the receiving member 71. However, the present disclosure is not limited to this configuration. For example, only a protrusion portion protruding in the circumferential direction from one edge of the sheet member 60 in the circumferential direction may be attached to the opposing drum body 52.

In this exemplary embodiment, the pair of protrusion portions 62B of the second attachment member 62 protruding on the opposite sides in the axial direction from the sheet member 60 is attached to the opposing drum body 52 through the receiving member 56. However, the present disclosure is not limited to this configuration. For example, only a protrusion portion protruding in the circumferential direction from the other edge of the sheet member 60 in the circumferential direction may be attached to the opposing drum body 52.

In this exemplary embodiment, as illustrated in FIG. 6, the central portion 61A of the first attachment member 61 is disposed in the range of the sheet member 60 as viewed in the thickness direction of the sheet member 60 (as viewed in the radial direction). However, the present disclosure is not limited to this configuration. For example, the central portion 61A of the first attachment member 61 may protrude in the circumferential direction from one edge of the sheet member 60 in the circumferential direction.

In this exemplary embodiment, as illustrated in FIG. 6 and FIG. 7, the positioning portion 75 positions the downstream edge portion of the sheet member 60 relative to the opposing drum body 52 such that the first attachment member 61 abuts against the upstream side of the positioning portion 75 in the circumferential direction. For example, the first attachment member 61 may be attached so as to move in the circumferential direction relative to the opposing drum body 52.

In this exemplary embodiment, as illustrated in FIG. 9, the positioning portion 76 positions the upstream edge portion of the sheet member 60 relative to the opposing drum body 52 such that the second attachment member 62 abuts against the downstream side of the positioning portion 76 in the circumferential direction. However, the present disclosure is not limited to this configuration. For example, the second attachment member 62 may be attached so as to move in the circumferential direction relative to the opposing drum body 52.

In this exemplary embodiment, the receiving member 71 to which the first attachment member 61 is attached and the receiving member 56 to which the second attachment member 62 is attached are each detachably attached to the opposing drum body 52. However, the present disclosure is not limited to this configuration. For example, at least one of the receiving member 71 and the receiving member 56 may be fixed or integral to the opposing drum body 52.

In this exemplary embodiment, the first attachment member 61 and the second attachment member 62 are respectively screwed to the receiving member 71 and the receiving member 56. However, the present disclosure is not limited to this configuration. For example, the first attachment member 61 and the second attachment member 62 may be respectively attached to the receiving member 71 and the receiving member 56 with an adhesive, such as a double-sided tape. Alternatively, the first attachment member 61 and the second attachment member 62 may be respectively attached to the receiving member 71 and the receiving member 56 by using an attachment mechanism, such as a clamp or a fastener.

### Second Exemplary Embodiment

### Image Forming Apparatus 200

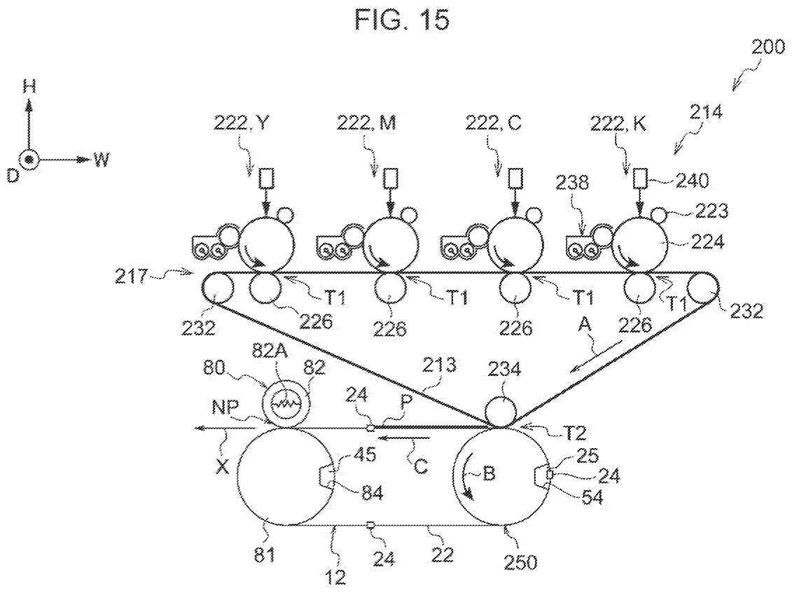

In the first exemplary embodiment, the image forming apparatus 10 is an ink-jet image forming apparatus for forming images on a recording medium P using ink. However, the image forming apparatus is not limited to this apparatus. The image forming apparatus may be any apparatus for forming images, such as an electrophotographic image forming apparatus. In a second exemplary embodiment, an electrophotographic image forming apparatus 200 will be described. FIG. 15 is a schematic view of the structure of the image forming apparatus 200 according to the exemplary embodiment. Portions having the same function as those in the first exemplary embodiment will be assigned with the same reference characters, and the description thereof may be omitted as appropriate.

### Image Forming Unit 214

The image forming apparatus 200 has an image forming unit 214 instead of the image forming unit 14. The image forming unit 214 has a function of electrophotographically forming a toner image (example image) on a recording medium P. More specifically, the image forming unit 214 has toner image forming units 222 and a transfer device 217 as illustrated in FIG. 15. The toner image forming units 222 form toner images, and the transfer device 217 transfers, to a recording medium P, the toner images formed by the toner image forming units 222.

### Toner Image Forming Units 222

The image forming apparatus 200 includes a plurality of the toner image forming units 222 illustrated in FIG. 15 to form a toner image for each color. In this exemplary embodiment, the toner image forming units 222 for total four colors, yellow Y, magenta M, cyan C, and black K, are provided. The toner image forming units 222 Y, 222 M, 222 C, and 222 K illustrated in FIG. 15 are components corresponding to those colors.

Since the toner image forming units 222 for the respective colors have the same structure except colors used, each part of the toner image forming unit 222 K, a representative of the toner image forming units 222, is assigned with the corresponding reference character in FIG. 15.

Specifically, the toner image forming unit 222 for each color has a photoreceptor 224. The photoreceptor 224 rotates in one direction (e.g., counterclockwise in FIG. 15). The toner image forming unit 222 for each color has a charger 223, an exposure device 240, and a developing device 238.

In the toner image forming unit 222 for each color, the charger 223 charges the photoreceptor 224. The exposure device 240 exposes the photoreceptor 224 charged by the charger 223 to form an electrostatic latent image on the photoreceptor 224. The developing device 238 develops the electrostatic latent image formed on the photoreceptor 224 by the exposure device 240 to form a toner image.

### Transfer Device 217

The transfer device 217 illustrated in FIG. 15 transfers, to the recording medium P, the toner image formed in each toner image forming unit 222. Specifically, the transfer device 217 first transfers, to a transfer belt 213 serving as an intermediate transfer body, toner images on the photoreceptors 224 for the respective colors such that the toner images are superposed on top of one another, and second transfers the superposed images to the recording medium P. As illustrated in FIG. 15, the transfer device 217 includes a transfer belt 213, first transfer rolls 226, and a transfer drum 250.

The first transfer rolls 226 transfer the toner images on the photoreceptors 224 for the respective colors to the transfer belt 213 at first transfer positions T1 between the photoreceptors 224 and the first transfer rolls 226. In this exemplary embodiment, the toner images formed on the photoreceptors 224 are transferred to the transfer belt 213 at the first transfer positions T1 in response to application of a first transfer electric field between the first transfer rolls 226 and the photoreceptors 224.

The toner images are transferred from the photoreceptors 224 for the respective colors to the outer circumferential surface of the transfer belt 213. As illustrated in FIG. 15, the transfer belt 213 is wound around a plurality of rolls 232 and an opposing roll 234 so as to form an endless shape and have a posture of an inverted triangle as viewed from the front (as viewed in the apparatus depth direction). The transfer belt 213 rotates in the direction of the arrow A as at least one of the plurality of rolls 232 is driven to rotate.

The transfer drum 250 is a roll that transfers, to the recording medium P at a second transfer position T2 between the opposing roll 234 and the transfer drum 250, the toner images that have been transferred to the transfer belt 213. In this exemplary embodiment, the toner images that have been transferred to the transfer belt 213 are transferred to the recording medium P at the second transfer position T2 in response to application of a second transfer electric field between the opposing roll 234 and the transfer drum 250. The transfer drum 250 has the same structure as the opposing drum 50 in the first exemplary embodiment.

### Fixing Device 80

In this exemplary embodiment, a fixing device 80 functions as a device for fixing, on the recording medium P, the toner images that have been transferred to the recording medium P by the transfer drum 250. Specifically, the fixing device 80 has a press roll 81 and a heating roll 82 as illustrated in FIG. 15.

A pair of sprockets 45 in the first exemplary embodiment is disposed on the opposite ends of the press roll 81 in the axial direction. The pair of sprockets 45 is coaxial with the press roll 81 and rotates together with the press roll 81. The outer circumference of the press roll 81 has a recess 84 for storing grippers 24 and attachment members 23.

In the fixing device 80, the heating roll 82 is disposed above the press roll 81. The heating roll 82 has a heat source 82A, such as a halogen lamp, inside the roll.

In the fixing device 80, for example, one of the press roll 81 and the heating roll 82 is driven to rotate, and the other one of the press roll 81 and the heating roll 82 rotates so as to follow the rotation. The press roll 81 and the heating roll 82 may both be driven to rotate.

In the fixing device 80, the toner images that have been transferred to the recording medium P are fixed on the recording medium P by heating and pressing the recording medium P while transporting the recording medium P sandwiched between the heating roll 82 and the press roll 81.

In the image forming apparatus 200, the transport mechanism 12 causes the recording medium P to pass through the second transfer position T2 and a fixing position NP between the press roll 81 and the heating roll 82 as chains 22 run in a running direction C with the leading edge portion of the recording medium P held by the grippers 24. The toner images that have been first transferred to the transfer belt 213 at the first transfer positions T1 for the respective colors such that the toner images are superposed on top of one another are second transferred to the recording medium P at the second transfer position T2. The toner images that have been second transferred to the recording medium P are fixed to the recording medium P at the fixing position NP.

The transfer drum 250 in this exemplary embodiment has the same structure as the opposing drum 50 in the first exemplary embodiment, and this exemplary embodiment achieves the same operation as the first exemplary embodiment.

The present disclosure is not limited to the foregoing exemplary embodiments, and various changes, modifications, and improvements can be made without departing from the spirit of the present disclosure. For example, a plurality of the modifications described above can be combined as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A drum member comprising:
a drum body having a hollow cylindrical shape;
a sheet member wrapped around the drum body; and
an elastic adhesive disposed between the drum body and the sheet member.

2. The drum member according to claim 1, wherein the elastic adhesive has an elastic modulus of less than 40 MPa and a tensile elongation at break of 40% or more.

3. The drum member according to claim 2, wherein the elastic adhesive has an elastic modulus of less than 3 MPa and a tensile elongation at break of 140% or more.

4. The drum member according to claim 1, wherein the elastic adhesive is a one pack-type room temperature-curable adhesive containing a modified silicone resin.

5. The drum member according to claim 2, wherein the elastic adhesive is a one pack-type room temperature-curable adhesive containing a modified silicone resin.

6. The drum member according to claim 3, wherein the elastic adhesive is a one pack-type room temperature-curable adhesive containing a modified silicone resin.

7. The drum member according to claim 1, further comprising an attachment part disposed on at least part of the sheet member and removably attached to the drum body,
wherein the sheet member and the attachment part are bonded to each other with the elastic adhesive.

8. The drum member according to claim 2, further comprising an attachment part disposed on at least part of the sheet member and removably attached to the drum body,
wherein the sheet member and the attachment part are bonded to each other with the elastic adhesive.

9. The drum member according to claim 3, further comprising an attachment part disposed on at least part of the sheet member and removably attached to the drum body,
wherein the sheet member and the attachment part are bonded to each other with the elastic adhesive.

10. The drum member according to claim 4, further comprising an attachment part disposed on at least part of the sheet member and removably attached to the drum body,
wherein the sheet member and the attachment part are bonded to each other with the elastic adhesive.

11. The drum member according to claim 5, further comprising an attachment part disposed on at least part of the sheet member and removably attached to the drum body,
wherein the sheet member and the attachment part are bonded to each other with the elastic adhesive.

12. The drum member according to claim 6, further comprising an attachment part disposed on at least part of the sheet member and removably attached to the drum body,
wherein the sheet member and the attachment part are bonded to each other with the elastic adhesive.

13. The drum member according to claim 7, wherein the attachment part has:
a first attachment part disposed on one edge portion of the sheet member in a circumferential direction and removably attached to the drum body; and
a second attachment part disposed on the other edge portion of the sheet member in the circumferential direction and removably attached to the drum body.

14. The drum member according to claim 8, wherein the attachment part has:
a first attachment part disposed on one edge portion of the sheet member in a circumferential direction and removably attached to the drum body; and
a second attachment part disposed on the other edge portion of the sheet member in the circumferential direction and removably attached to the drum body.

15. The drum member according to claim 9, wherein the attachment part has:
a first attachment part disposed on one edge portion of the sheet member in a circumferential direction and removably attached to the drum body; and
a second attachment part disposed on the other edge portion of the sheet member in the circumferential direction and removably attached to the drum body.

16. The drum member according to claim 10, wherein the attachment part has:
a first attachment part disposed on one edge portion of the sheet member in a circumferential direction and removably attached to the drum body; and
a second attachment part disposed on the other edge portion of the sheet member in the circumferential direction and removably attached to the drum body.

17. The drum member according to claim 11, wherein the attachment part has:
a first attachment part disposed on one edge portion of the sheet member in a circumferential direction and removably attached to the drum body; and
a second attachment part disposed on the other edge portion of the sheet member in the circumferential direction and removably attached to the drum body.

18. The drum member according to claim 7, wherein the attachment part is disposed on an entire inner circumferential surface of the sheet member and removably attached to the drum body.

19. The drum member according to claim 1, wherein the sheet member and the drum body are bonded to each other with the elastic adhesive.

20. An image forming apparatus comprising:

1. m member according to claim 1 that transports a recording medium; and
an image forming unit that forms an image on the recording medium transported by the drum member.
